(19) United States
(12) Patent Application Publication
(10) Pub. No.: US 2005/0186895 A1
(43) Pub. Date: Aug. 25, 2005

(54) Decropping tool and wrapped cam for use in food processing machinery

(76) Inventors: Antoine J.H. Winkelmolen, Shawnee, KS (US); Mitchell Scott Stockton, Lawrence, KS (US)

Correspondence Address: SPENCER, FANE, BRITT & BROWNE, 1000 WALNUT STREET, SUITE 1400, KANSAS CITY, MO, 64106-2140, US

(21) Appl. No.: 10/764,859

(22) Filed: Jan. 26, 2004

(51) Int. Cl. A22B 5/18

(52) U.S. Cl. 452/117

(57) ABSTRACT

A tool, or probe, is provided for insertion into a avian or poultry carcass for removing the crop and/or windpipe and/or gullet and/or other undesired viscera from the neck of the bird carcass. The probe has helical threads protruding from a probe body. V-shaped voids are cut into the helical threads to provide teeth for removal of the crop and other inedible viscera from the carcass. A cam and method of manufacturing a cam for use in decropping machines and other food processing machinery is provided. The cam includes plastic guides that are pre-shaped in two dimensions and then wrapped about a three dimensional cam frame to provide a desired path for a cam follower.

### FIELD OF THE INVENTION

The present invention relates, generally, to poultry processing devices and other machinery used in food processing. One aspect of the invention relates to a system for removing the crop, gullet and viscera from poultry carcasses that have been previously slaughtered and at least partially eviscerated as the poultry carcasses are suspended by their legs and moved in series along an overhead conveyor. In particular, this aspect of the present invention relates to a probe or probe tip for attachment to a probe arm, or decropping tool, that is inserted into the neck of an eviscerated and decapitated carcass for capture and removal of the crop and/or windpipe and/or gullet from the neck of the bird carcass. In addition, the present invention relates to a cam for use in a decropping machine, or in other food processing machinery that utilize cam controlled movement.

### BACKGROUND OF THE INVENTION

In the processing of poultry, chickens for example, a bird is beheaded, defeathered and eviscerated by cutting a vent in the bird and removing the heart, liver, intestines, lungs and other viscera from the bird. Various means for automated effecting of the foregoing operations are known in the art.

Following the above decapitation and evisceration process, it is necessary to remove the crop and gullet and possibly some remaining viscera from the bird. This can be done by hand, but in recent years automated equipment has been developed for removing the crop, etc. from birds. In general, the bird carcass hanging neck down on a conveyor with the carcass breast part facing either toward or away from a processing machine, passes to a decropping operation wherein carcass parts commonly accepted as being inedibles are removed using a probe, these parts comprising the crop, trachea, esophagus, and membrane. After the crop has been pulled as described above, the probes are generally cleaned and then retracted in an upward direction so the probe heads are withdrawn back through the bird before the bird moves with the conveyor line away from the machine.

The automated equipment in common use at the present time for the removal of the crops of birds comprises a rotary machine placed in the overhead conveyor line of a poultry processing plant. The conveyor line rotates an outer turret of the machine about an inner stationary support frame. The inner stationary support frame includes a cam. Cam followers are attached to probes mounted at the circumference of the turret that revolve with the turret. As the birds are moved about the cam via the turret, the probes following the cam move downwardly into the previously opened vents of the birds, and downwardly through the neck opening of the birds and pull the crops and other viscera with them as they move out of the neck openings. The probes usually are rotated during its downward movement, and the heads of the probes include teeth or other protrusions that tend to gather the crop, etc. during the rotational movement. After the crop has been pulled as described above, the probes are then retracted by following the cam track in an upward direction so that the probe heads are withdrawn back through the bird before the bird moves with the conveyor line away from the machine. U.S. Pat. No. 4,610,050 to Tieleman et al., U.S. Pat. No. 4,788,749 to Hazenbroek et al., and U.S. Pat. No. 5,597,350 to Hunking et al., incorporated herein in their entirety by reference, disclose crop removal machines of this general type.

As discussed above, automated crop removal can be accomplished with a rotary probe which enters the carcass cavity to remove the crop and other viscera parts by grabbing same, the probe being designed to enter and pass down through the neck passage and outwardly of the carcass, the removed crop and other viscera parts then being cleared from the probe before it retracts upwardly through the carcass for a new decropping operation. The inventions described in U.S. Pat. Nos. 4,610,050 and 4,788,749 are representative of such probe devices.

The rotary probes described in the above-referenced patents, as well as most others used in the industry, are rigid, for example, metal components. Further the probes have rigid teeth, commonly placed at opposite diametrical locations on the probe. If a carcass that is to be decropped is only slightly misaligned with respect to the operating travel path of the rotary probe, the probe, which travels a fixed course through the carcass, may drive through the side of the carcass. The resulting damage can require reworking of the carcass, or even render the carcass incapable of reworking and thus result in a loss of yield.

Another disadvantage of prior art rotary probes is the potential for damage caused by the rigid teeth of the probe. The teeth are used to grab the membrane, crop, etc. to be removed. In doing this, as well as in passing through the carcass generally, these rigid elements can strike and break carcass ribs, shoulder bones, pulley bones, etc., and the tooth action also can chew up the neck bone. All such damage leads to additional problems in subsequent processing of the carcass. Yet another disadvantage of prior art probes is due to the orientation and arrangement of the teeth, which usually comprise rather large open areas or voids. The existence of such larger voids makes the capture of smaller and springier tissues difficult.

While newer probes, such as those described in U.S. Pat. No. 5,597,350, have been developed that are flexibly structured to greatly reduce damage caused by misalignment of the probe with the carcass and damage caused by the probe teeth, the aggressive shape and/or orientation of the teeth continue to cause carcass damage. Moreover, increasing the flexibility of the probe teeth results in decreased effectiveness in removal of the crop from the carcass. Therefore, it is desirable to provide a probe that reduces damage caused by misalignment and by probe teeth encountering obstructions (such as bones), while at the same time maintaining effective crop removal.

Most prior art probes require the inclusion of a blunt foremost tip, or distal probe end, which defines the maximum diameter of the probe and the teeth extending from the probe. The purpose of such a distal probe end is to provide a “lead-in” for the probe teeth. The lead-in protects the teeth from breaking as the probe initially enters and moves through the carcass. While the lead-in tip does help to protect the teeth from breaking, it primarily benefits the teeth most closely positioned to the tip. This single lead-in does not provide protection for individual teeth, especially located away from the distal end of the probe. Therefore, it would be beneficial to provide a lead-in for a probe that protects individual teeth, especially those situated away from the distal end of the probe.

The cam discussed above with respect to the decropping machines of the prior art is similar to the cams used in numerous other food processing machinery of the prior art, such as the product transfer station described in U.S. Pat. No. 5,725,082, the disclosure of which is incorporated herein by reference. Due to USDA requirements, the materials from which cams for decropping machines, product transfer stations, and other food processing machinery, can be constructed is limited primarily to stainless steel or plastic. Thus, two variations of prior art cams currently exist for food processing machinery; a welded steel cam, and a machined nylon or plastic cam. Both prior art cams are extremely labor intensive and expensive to manufacture.

Manufacture of the welded steel cam generally requires that linear steel tubing (rods, strips, channels or the like) be incrementally bent about a cam frame and welded to the generally cylindrical or conical cam frame to form the cam track. Due to the difficulty of bending the steel tubing to form the desired position of the cam track, manufacture of a steel cam is extremely time consuming and often inaccurate. Often the steel cam frame is a steel drum, from the surface of which the cam track protrudes. Alternatively, the frame is sometimes manufactured in a more open framework arrangement to allow for easier cleaning of the machine.

FIGS. 8 and 8A show a welded steel cam assembly of the prior art intended for use with a decropping machine. FIG. 8 shows welded steel cam 63 statically mounted to vertical axle 72 within a turret assembly. FIG. 8A shows welded steel cam 63 statically mounted to vertical axle 72, with the turret assembly removed. Vertical axle 72 is mounted to a support frame (not shown). The turret assembly includes lower rotary disk 76 and upper rotary disk 74, which are mounted to vertical axle 72 via rotational bearings. A plurality of guide rods 52 extend between the outer peripheries of lower disk 76 and upper disk 74, with guide rods 52 being attached at their upper ends to upper disk 74. Although two guides rods 52 are shown in FIG. 8 for purposes of example, it is understood that additional guide rods can be included in actual operation of the decropping machine arranged in a circumferential array about lower disk 76 and upper disk 74. The combination of lower disk 76, upper disk 74, and guide rods 52 form a rigid turret that is rotatable about stationary vertical axle 72 and stationary cam 63.

Cam 63 is positioned inside the array of guide rods 52 and is mounted in fixed relationship with respect to stationary vertical axle 72. Cam track 67 is formed by a pair of rails or tubes that is welded to and protrudes from the outer surface of cam 63. Transmission components 54 are slideably mounted to guide rods 56 and each includes a cam follower roller 62 (not shown) that rides within cam track 67 so as to move upward and downward as the turret and guide rods 52 are rotated around cam 63. Probe rods 56 are mounted to transmission components 54 so as to slide up and down with transmission components 54. Probes 60 are mounted to the end of probe rods 56 upward and downward movement with transmission components 54 and probe rods 56. Transmission components 54 also include a drive mechanism (not shown) which provides rotation of probe rods 56 and probes 60 as they move up and down through a carcass.

As an alternative to the welded steel cam, the other variation of the prior art cams for use in food processing machinery is manufactured of nylon. Such a cam is machined from a large block or drum of nylon wherein the cam track is grooved into the nylon. The machined cam allows for increased accuracy of the cam track over that of the welded steel cam. Nevertheless, such a large block of nylon is of itself extremely expensive, and the machining is time consuming and costly. In addition, it is extremely difficult, if not impossible, to manufacture a nylon cam having an open framework, as such a cam is machined from a single piece of nylon. While nylon cams are often machined down close to the cam track, there still exists a single, continuous ring of nylon. Thus, cleaning of machines utilizing nylon cams is often difficult.

FIGS. 9 and 9A show a machined nylon cam assembly of the prior art intended for use with a decropping machine. FIG. 9 shows nylon cam 63 statically mounted to vertical axle 72 within a turret assembly. FIG. 9A shows nylon cam 63 statically mounted to vertical axle 72, with the turret assembly removed. The turret assembly shown in FIG. 9 is constructed and operates in the same manner as the turret assembly described above with respect to FIG. 8, the only difference being the use of a nylon cam in place of the welded steel cam. Nylon cam 63, shown in FIGS. 9 and 9A, include cam track 67 which is a channel or groove machined into (instead of protruding from) the cam surface.

A disadvantage of both the welded steel cams and the machined nylon cams of the prior art discussed above, is the fact that the cam tracks cannot be altered once the cam is manufactured. Thus, if it is desired to change the cam track path in a machine for any reason, such as to alter the rate in which a decropper probe moves downward or upward through a carcass, it is necessary to disassemble the machine, remove the cam and install a new cam. Such a process can be extremely time consuming and expensive. In addition the path of a cam track is manufactured into the cam based upon the direction of rotation (i.e. clockwise or counter-clockwise). If the path has the proper shape, but is manufactured into the cam in the wrong direction, the machine usually will not function, and a new cam is necessary. If a cam is being replaced in an existing machine, and the wrong cam is obtained (i.e. clockwise when a counter-clockwise is required), the machine will often be out of service until a new cam can be ordered and delivered. This can be extremely costly to a food processing facility. Therefore, it is desirable to provide a cam for use in food processing machinery that is easier and less expensive to manufacture and clean than those of the prior art, and which has a cam path that is easy to reverse and/or modify.

### SUMMARY OF THE INVENTION

Accordingly, it is an object of the invention to provide a probe for use in poultry decropping apparatus which overcomes the drawbacks of the prior art.

It is another object of the invention to provide a probe for poultry decropping apparatus which functions while producing fewer broken carcass bones and other incidents of carcass damage.

Another object of the invention to provide a probe for poultry decropping, the employment of which results in less carcass rework, higher meat yield and a safer final product.

Yet another object is to provide a probe for poultry decropping which removes a higher percentage of membrane, crop, trachea and esophagus inedibles from a poultry carcass than possible with known probe constructions.

A still further object is to provide a probe for poultry carcass decropping which is flexibly structured to minimize its potential to cause carcass damage yet is highly effective to the end of snagging and removing and pulling away inedibles from the carcass.

Another object is to provide a probe for poultry carcass decropping which is easier to clean than prior probes and therefore lessens processing contamination.

A further object is to provide a probe having tissue support portions, or lead-ins, positioned precedent to the snagging tooth or void to space more continuously rigid tissues from capture in the void and to allow smaller and springier tissues to be captured in the void or by the teeth.

Another object of this invention is to provide a durable and inexpensive poultry crop removal system which functions reliably to remove the crop and related viscera from birds as the birds move in series through an automated poultry processing system.

Another object of this invention is to provide an improved probe head which is effective to engage and gather the crop and related viscera of a bird as the probe head moves downwardly through the visceral cavity and through the neck opening of a decapitated, partially eviscerated bird.

The objects of the instant invention are accomplished through a probe that includes a probe head of special design that is adapted to engage the crop, gullet and related viscera as the probe rotates and moves through the visceral cavity and neck opening of the bird. The probe includes a generally cylindrical support surface from which helical threads protrude. V-shaped voids are cut into the helical threads to form teeth. The outer diameter of the helical threads function as lead-ins for each tooth.

An additional object of the instant invention is to provide an improved cam assembly for use with a decropping machine and various other machinery, and especially food processing machinery.

Another object of the instant invention is to provide a cam assembly that is easy to manufacture with a high degree of cam path accuracy, and which is easy to clean during or after operation.

Yet another object of the instant invention is to provide a cam assembly for which the cam path is reversible and/or easily modified.

The objects of the instant invention are accomplished through a cam assembly that includes a cam frame and plastic guides mounted to the frame. The guides are made from a two-dimensional sheet of plastic and wrapped around the three-dimensional frame.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a vertical central section of a poultry carcass depicting the location in the carcass of the crop and certain other inedibles that are to be removed in a decropping operation;

FIG. 2 is an elevational view with parts in section of apparatus with which decropping of a poultry carcass can be carried out, the apparatus being fitted with the probe of the instant invention;

FIG. 2A is a fragmentary elevational view on enlarged scale of a decropping unit portion of the apparatus showing details of the cropping unit mounting and means by which rotation and sliding of the probe is effected;

FIG. 3 is a side view of the probe of the instant invention;

FIG. 4 is an end plan view of the probe shown in FIG. 3;

FIGS. 5 and 5A are side perspective views of the probe shown if FIGS. 3 and 4;

FIG. 6 is a vertical sectional view of a poultry half carcass showing the deflection of a flexible embodiment of the probe of the instant invention when it encounters the carcass breast due to misalignment of the suspended carcass.

FIG. 7 is a vertical sectional view through a poultry half carcass showing how the inventive probe widens the neck passage incident to travel therein for removal of the inedibles;

FIG. 8 is a side perspective view of a turret and cam assembly utilizing a prior art welded cam;

FIG. 8A is a side perspective view of the cam assembly shown if FIG. 8 removed from the turret assembly;

FIG. 9 is a side perspective view of a turret and cam assembly utilizing a prior art machined nylon cam;

FIG. 9A is a side perspective view of the cam assembly shown if FIG. 9 removed from the turret assembly;

FIG. 10 is a side perspective view of a turret and cam assembly utilizing the cam of the instant invention;

FIG. 10A is a side perspective view of the inventive cam assembly shown if FIG. 10 removed from the turret assembly;

FIG. 10B is a side perspective view of the inventive cam assembly of FIGS. 10 and 10A showing a follower guide unwrapped from the cam frame.

### DESCRIPTION OF THE PREFERRED EMBODIMENT

As required, detailed embodiments of the present inventions are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

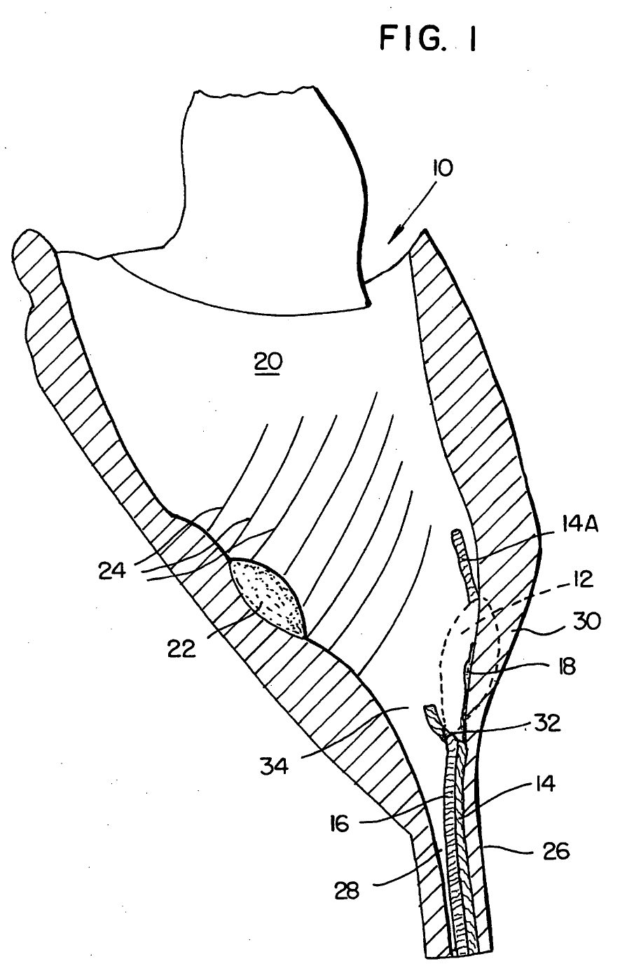

Reference is made to FIG. 1 to allow a general description of the poultry carcass decropping operation contemplated by the instant invention. Carcass 10 (only a half section thereof being shown in FIG. 1) arrives at the decropping operation headless and defeathered. The carcass is in an upside-down orientation with the neck portion of the carcass facing the floor.

The stomach cavity previously has been cleaned of certain poultry parts, and the purpose of decropping is to remove certain inedible carcass parts which comprise crop 12, esophagus 14, trachea 16 and numerous areas of membrane 18. Membrane 18 lines parts of cavity 20 and is also entwined with and overlays the other inedibles shown in FIG. 1. Also shown in FIG. 1 are lung 22, carcass ribs 24 and carcass neck 26 having passage 28 wherein both the trachea and esophagus extend.

Crop 12 is depicted in dashed line to reflect that the crop lies behind the plane of the view shown in FIG. 1 to one side of carcass intermediate meat 30 of carcass 10, and the skin; the crop being close to the shoulder and being attached to the esophagus as at 32. In the decropping process, a decropping tool carrying a probe is inserted in cavity 20. During its travel downwardly toward neck passage 28 the probe will snag trachea part 14A first to start a capture and pulling of crop 12 and rotating to bring crop 12 into the cavity and moving downward toward portal 34 of neck passage 28. As the probe arrives at portal 34 it is carrying trachea part 14A and it may also have started a snagging of membrane 18 such that a good grip on the inedibles by the probe is first realized.

As the probe passes through neck passage 28, pull away of trachea 14, membrane 18 and esophagus 14 continues so that eventually the neck passage is free of those inedibles. Once outside of carcass 10 and below neck 26, the inedibles will be cleaned from the probe with, for example, a counter rotating brush. Following removal of the inedibles from the probe, the rotation of the tool will be reversed as the tool and probe thereon are raised back up through and out of the decropped carcass ready for the next operating cycle on a new carcass. Proper entry of the probe into the portal region 34 of the neck passage, without encountering any obstruction within the cavity, requires appropriate alignment of the carcass with respect to the fixed travel path of the probe. Obtaining appropriate carcass alignment is often difficult, if not impossible. Thus, the rigid probe constructions of the prior art, coupled with the rotating nature of the probe, can result in unwanted damage to the carcass such as puncture of the carcass or the breaking of bones within the carcass. Such damage requires carcass rework and even meat yield loss, which can be very costly to a poultry processing facility.

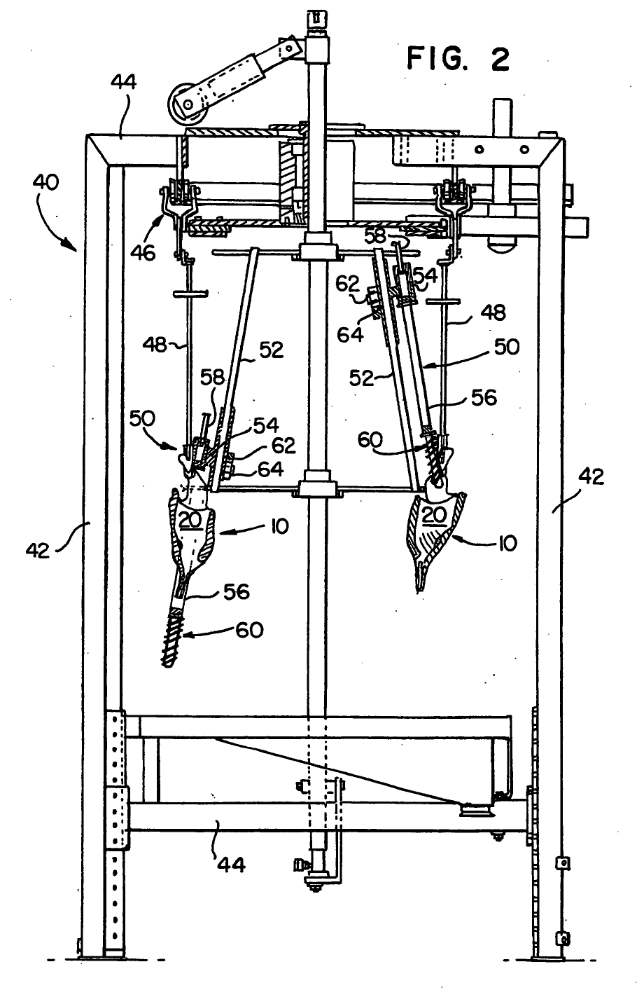

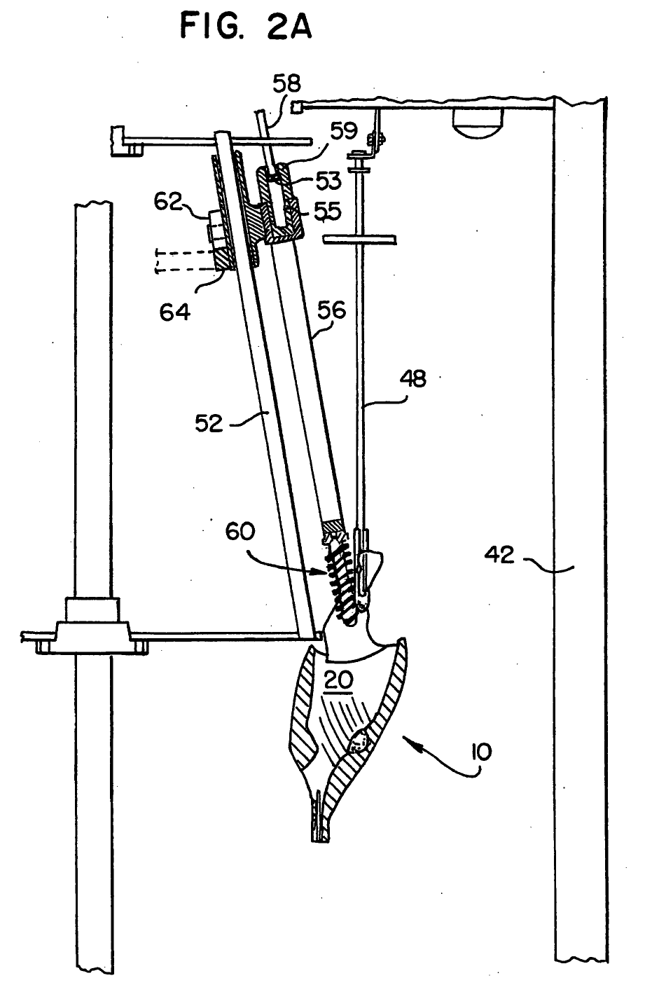

Referring now to FIGS. 2 and 2A, a decropping station portion of poultry carcass apparatus 40 is shown, Except for the probe and cam (not shown in detail) of the instant invention embodied in FIGS. 2 and 2A, of the depicted apparatus is of generally known construction. The apparatus described U.S. Pat. Nos. 4,610,050, 4,788,749, and 5,597,350 are exemplary of the apparatus shown in FIGS. 2 and 2A.

Apparatus 40 includes upright and crosswise support framing 42 and 44, respectively, which carries moving components such as conveyor 46 having shackles with hangars 48 from which suspended carcasses 10 hang. Carcasses 10 pass serially through the decropping station. Each carcass 10 hangs by the legs with its breast facing inwardly toward the machine, although carcass orientation could be reversed so that the carcass back faces the machine without effecting the decropping process. Associated with each carcass 10 is a decropping, or inedibles removal unit, shown generally at 50, decropping unit 50 travels in tandem with the shackles. The shackle/decropping unit travel is such that during the decropping operation, the carcass 10 shown at the right of FIG. 2 approaches the viewer and makes a turnaround 180 degrees to the left so as to depart from the viewer, with the decropping occurring during this approaching and departing travel.

Each decropping unit 50 includes a guide bar, 52, on which is carried transmission component 54 which transmits rotary and sliding movement to tubular rod 56. Probe 60 is attached to the end of tubular rod 56. Transmission component 54 is mounted to slide along guide bar 52. Transmission component 54 also includes bearing 55 for rotary support of transmission component 54. Transmission component 54 is rotated via square drive rod 58 which is driven from above transmission component 54 by means and manner known in the art. Rod 58 engages with square opening 53 in cap 59 of bearing 55 such that rotation of rod 58 produces rotation of tubular rod 56, and in turn, probe 60. Each transmission component 54 also includes cam follower roller 62, which rides on fixed cam guide 64. As each decropping unit travels around the decropping station, transmission component 54 and hence, the probe 60 associated therewith, is slid downward and then upward in the straight line of travel defined by the longitudinal axis of probe 60.

The embodiment of probe 60 shown in FIG. 2 will be described further with reference to FIGS. 3-5. Probe 60 has an elongated probe body (or support surface) 66, preferably of cylindrical or conical configuration and on which is carried a plurality of teeth 68, the teeth 68 being formed by cutting V-shaped voids 84 in helical threads 81, 82 and 83 that extend along and protrude from probe body 66. Threaded void 69 is located in the base end of probe 60, opposite to probe distal end 88, to permit probe 60 to be removably attached to probe rod 56 of a decropping machine. The teeth 68 advantageously are made integral with probe body 66 as by molding, machining or likewise forming the probe body and teeth.

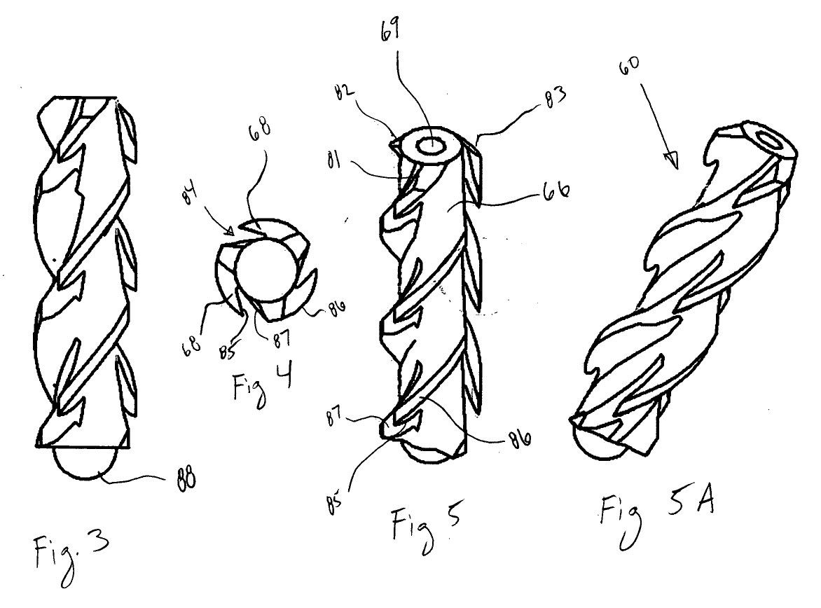

In the embodiment shown in FIGS. 3-5, V-shaped voids 84 are made in threads 81, 82 and 83 by making two separate cuts along a line tangent to the cylindrical support surface 66. A first cut is made along tangent line 87, and a second cut is made along tangent line 85. In a preferred embodiment the angle between tangent lines 85 and 87 is an acute angle, preferably between 5 and 10 degrees. Such results in a relatively narrow void, increasing the potential for snagging inedibles. In addition, the existence of an acute angle reduces the exposure of tooth leading edge 85 to obstructions as probe 60 travels through a carcass. As shown in FIG. 4, tangent cuts 85 and 87 are made along the entire length of the of probe body 66, such that multiple teeth 68 are located along a single line that is parallel to the longitudinal axis of probe body 66. Such an arrangement allows for easier cleaning of the probe as a brush can easily be drawn through the aligned voids and across the aligned teeth.

Outer edges 86 of threads 81, 82 and 83 define an outermost, or maximum, diameter of probe 60. As probe 60 rotates through a carcass, the foremost ends of threads 81, 83 and 83, which terminate near probe distal end 88, will function as lead-ins for the first of teeth 68 to engage with the carcass the is being decropped. The lead-in functions to protect teeth 68 from breaking as the probe initially enters and moves through the carcass. As probe 60 continues to rotate, the first teeth will function as lead-ins for subsequent teeth. Such is possible because outer edge 86, which is the trailing surface of teeth 68, defines the maximum diameter of the probe and shelters the trailing teeth as they rotate through the carcass.

Although support surface 66 of probe 60 shown in FIGS. 3-5 is generally cylindrical in shape and the outer perimeters of threads 81, 82 and 83 are also generally cylindrical in shape, it will be appreciated that various alternative shapes can be utilized without departing from the spirit or scope of the invention. For example, in an alternative embodiment of the instant invention, the support surface 66 and the outer perimeters of threads 81, 82 and 83 are generally conical in shape. In this manner, the diameters of threads 81, 82 and 83, and likewise the diameter of probe 60, increase from distal end 88 toward the base of probe 60 and the maximum diameter of the probe will be located at or near the base of probe 60. Nevertheless, the outer perimeter of the helical thread still functions as a lead-in for trailing teeth in the manner describe above. In addition, it will be appreciated that the shape of support surface 66 and that of threads 81, 82 and 83 can vary from each other and do not require a generally circular or cylindrical cross section. For example, support surface 66 could have a generally square or rectangular shape, while threads 81, 82 and 83 are generally cylindrical in shape. Furthermore, it is understood that the term “diameter” as used in the instant application and the appended claims, in no way dictates the shape of any object to which that term refers. Specifically, it is understood that the term “diameter” may refer to a line passing through the center of any figure, including but not limited to a circle, sphere, cylinder, square, cube, rectangle, or triangle.

In a preferred embodiment the thread pitch is approximately between 30 and 120 millimeters, with a thread pitch of approximately 60 millimeters being preferred. Such a thread pitch provides a suitable angle of attack for the teeth to move forward through carcass 10 adequately removing the inedibles while also limiting the aggressiveness of the decropping procedure. Decreasing thread pitch will result in increased crop engagement with the teeth as a higher number of rotations will be necessary to move the probe through the same length of carcass 10; however, decreasing thread pitch will also result in a more aggressive angle of attack of teeth 68 with the sides of carcass 10 and will be more likely to result in carcass damage.

In the preferred embodiment of the instant invention shown in FIGS. 3-5, probe 60 includes three helical threads, 81, 82, and 83, each spaced approximately 120 degrees apart from one another. The use of multiple threads 81, 82 and 83 provides three separate paths through carcass 10 along the same length of probe 60 as would be present with a single thread. Such allows multiple opportunities for teeth 68 to engage with the inedibles in carcass 10, while at the same time permitting the angle of attack of each tooth 68 to be reduced with respect to the side of carcass 10. The helical threads of the preferred embodiment of probe 60 shown in FIGS. 3-5 have a slightly concave shape, as opposed to being primarily perpendicular to probe body 66, to further reduce the angle of attack of each tooth with respect to the sides of carcass 10.

In a preferred embodiment, polymeric based compositions are used for constructing probe 60, including teeth 68, to be flexibly structured. In such a preferred embodiment, a selected polymer will be one approved by the USDA for use with dry, aqueous and fatty foods. Particularly suited is a urethane based material made from VIBRATHANE 8007 prepolymer manufactured by Uniroyal Chemical Company, Inc. of Middlebury, Conn. cured with VIBRACURE A 125 extender of the same company or with 1,4 Butanediol or mixtures of these extenders. It is appreciated that other materials, such as plastics, resin, metal, and which may or may not result in flexible structure of probe 60 or teeth 68, could be used to construct probe 60 without departing from the scope of the instant invention.

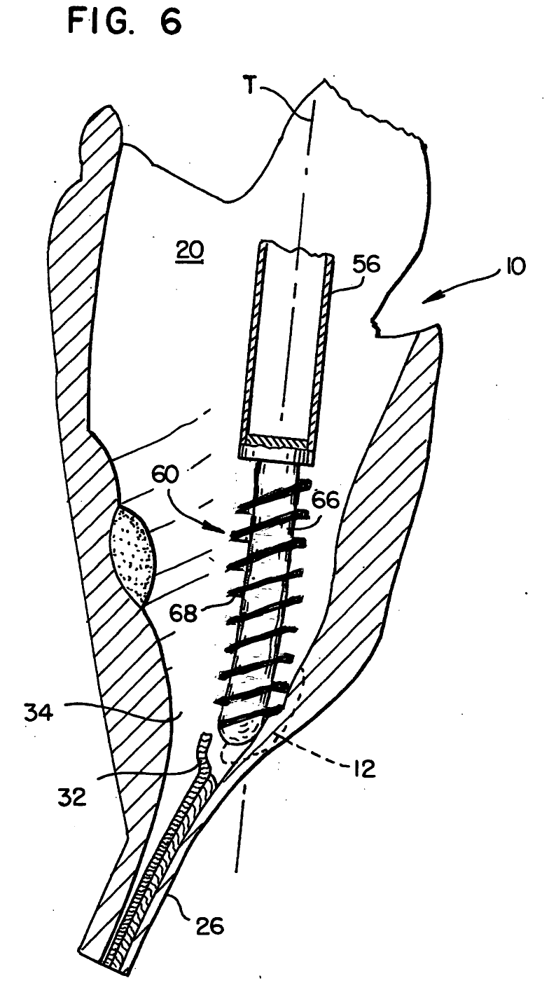

FIG. 6 shows a carcass-probe misalignment condition, i.e., where probe longitudinal axis T is offset relative to portal 34, such that a non-flexible probe will most likely result in damage to the carcass. In FIG. 6, the misalignment is shown as such that axis T intersects the breast side of the carcass. It is equally possible that misalignment could occur at the other side of the carcass, i.e., the carcass back side or either flank of the carcass, such that axis T intersects the carcass. As the tip of a flexibly structured probe 60, such as that of the preferred embodiment discussed above, encounters the breast or the back side of the carcass, deflection (bending) of probe 60 will occur and damage to the carcass will be avoided.

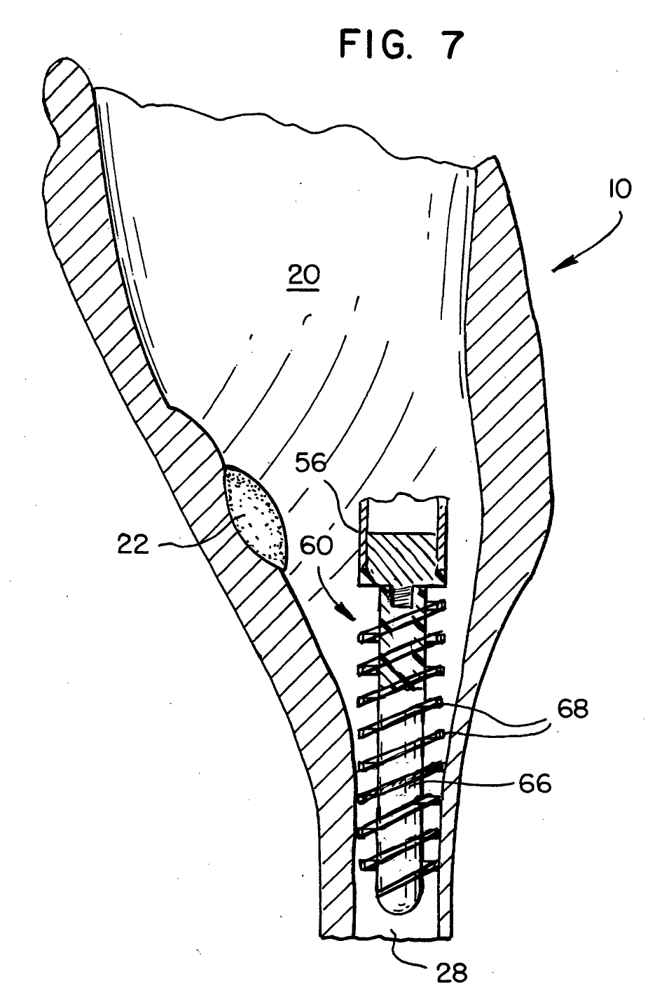

Entry of the probe tip end into the neck passage from the portal will force spreading enlargement of the neck structure to accommodate the probe pass through. In pass through of the neck passage, probe 60, positioned as shown in FIG. 7, will snag any membrane therein, will pull away the trachea and esophagus portions in the neck as well as the inedibles pulled away earlier so that as the probe passes out of the neck it will pull along the trailing removed inedibles in addition to those snagged and wrapped around the probe itself.

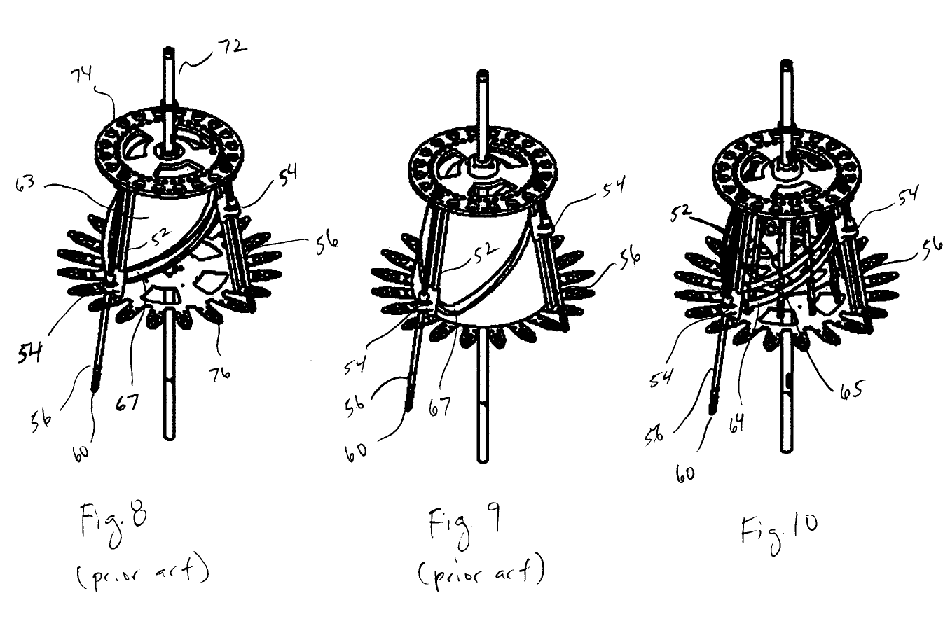

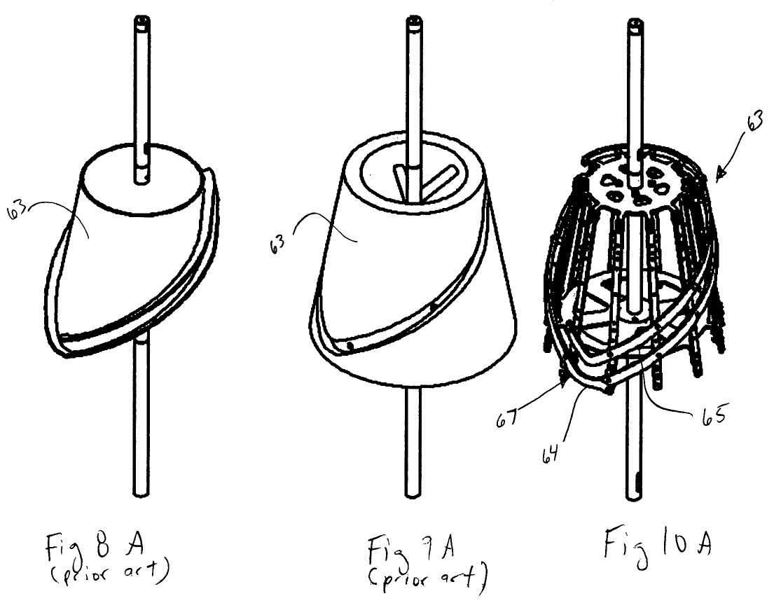

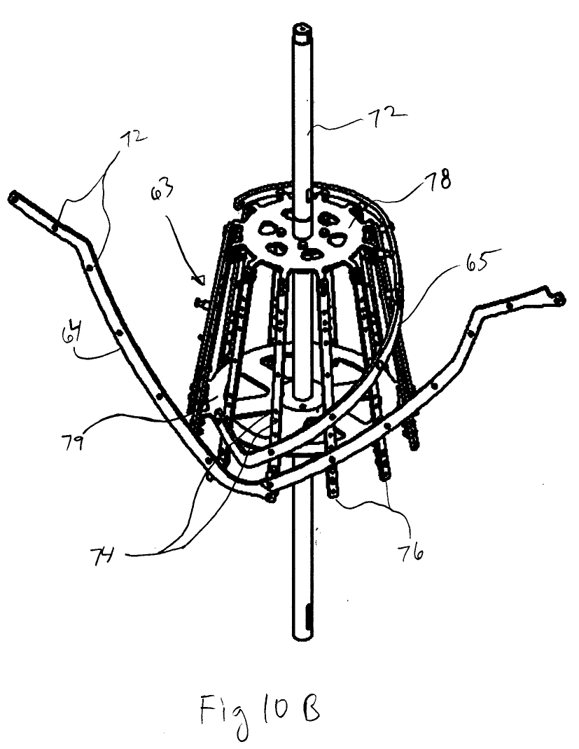

FIG. 10 shows the wrapped cam assembly of the instant invention as it is used with a decropping machine. In FIG. 10 wrapped cam 63 is statically mounted to vertical axle 72 within a turret assembly of a decropping machine. FIG. 10A shows wrapped cam 63 statically mounted to vertical axle 72, without the turret assembly shown in FIG. 10. As discussed above with respect to the prior art cam assemblies, vertical axle 72 is mounted to a support frame (not shown). The turret assembly includes lower rotary disk 76 and upper rotary disk 74, which are mounted to vertical axle 72 via rotational bearings. A plurality of guide rods 52 extend between the outer peripheries of lower disk 76 and upper disk 74, with guide rods 52 being attached at their upper ends to upper disk 74. Although two guides rods 52 are shown in FIG. 8 for purposes of example, it is understood and appreciated that additional guide rods can be included in actual operation of the decropping machine arranged in a circumferential array about lower disk 76 and upper disk 74. The combination of lower disk 76, upper disk 74, and guide rods 52 form a rigid turret that is rotatable about stationary vertical axle 72 and stationary cam 63.

Wrapped cam 63 is positioned inside the array of guide rods 52 and is mounted in fixed relationship with respect to stationary vertical axle 72. Cam 63 is made of a steel frame or cage that includes upper support member 78, lower support member 79, and a plurality vertical support members 76 which are connected together to form the frame of rigid cam 63. Upper support member 78 and lower support member 79 are statically connected to vertical axle 72 to provide the fixed relationship between cam 63 and axle 72.

Cam track 67 is formed by a pair of guide rails, or plastic strips (64 and 65), that are wrapped around the cage of cam 63 and attached to vertical support members 76. Transmission components 54 are slideably mounted to guide rods 56 and each includes a cam follower roller 62 (not shown) that rides within cam track 67 so as to move upward and downward as the turret and guide rods 52 are rotated around cam 63. Probe rods 56 are mounted to transmission components 54 so as to slide up and down with transmission components 54. Probes 60 are mounted to the end of probe rods 56 for upward and downward movement with transmission components 54 and probe rods 56. Transmission components 54 also include a drive mechanism (not shown) which provides rotation of probe rods 56 and probes 60 as they move up and down through a carcass.

FIG. 10B illustrates how cam path 67 for the wrapped cam of the instant invention is made. FIG. 10B shows lower boundary plastic guide 64 in an unwrapped, planar arrangement, and upper boundary plastic guide 65 after it has been wrapped about cam 63. A desired cam path is established about the three-dimensional cam 63 based upon the path of travel desired for the cam follower. The desired cam path generally includes an upper boundary and a lower boundary. The three-dimensional upper and lower boundaries are translated into two-dimensional representations, such that when the two-dimensional representation is wrapped around the surface of cam 63, it will form the three dimensional boundary. In other words, the cam surface is essentially unwrapped from its three-dimensional shape and into a flat shape. This unwrapping of the three-dimensional boundaries into two-dimensional representations can be accomplished physically, mathematically, by modeling, or by any other means currently known or later discovered. In the preferred embodiment, the two-dimensional representations are determined through the use of mathematical modeling.

Once two-dimensional representations of the upper and lower boundaries are determined, those representations will be utilized to shape upper and lower plastic guides, 65 and 64 respectively. Plastic guides 64 and 65 are cut from a flat sheet of plastic using any suitable cutting tool known or discovered. In the preferred embodiment, either a laser or water jet cutter is used for production efficiency and accuracy. The plastic guides are then wrapped around cam 63 and attached to vertical support members 76 at the appropriate position for the desired cam path.

Plastic guides 64 and 65 include a plurality of voids or holes through which bolts, screws, or other means for attachment can be extended to attach the guides to support members 76. Likewise, support members 76 include a plurality of voids or holes through which bolts, screws, etc. can be extended and which align with the holes located in the plastic guides. In addition, support members 76 of the shown embodiment include extra holes along the length of the support member to provide alternative locations for the attachment of either additional plastic guides, or plastic guides of varying cam paths. Such an arrangement allows cam path 67 for any cam 63 of the instant invention to be easily modified by removing the plastic guides and installing new ones without the need for replacement of the entire cam assembly as is necessary in prior art assemblies. In addition, in the event it is desired or else required to reverse the direction of the cam while maintaining the original cam path, such can be accomplished merely by removal of plastic guides 64 and 65 from the cam, turning the guides over and reinstalling to the cam. Thus, the need to maintain two separate cams having identical but reversed cam paths present in the prior art is eliminated. Furthermore, custom cam paths can be quickly, easily and cost-efficiently manufactured.

It will be appreciated, that although wrapped cam 63 of the instant invention and shown in FIGS. 10, 10A and 10B is shown in connection with a decropping machine, the wrapped cam is intended to, and will be, used in connection with any machinery in which cams are utilized, including but not limited to the product distribution station disclosed in U.S. Pat. No. 5,725,082, and/or other food processing machinery.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive apparatuses and methods are constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

1. A probe for attachment to a rotatable probe shaft, for removing undesired viscera from the neck of an eviscerated and decapitated bird carcass comprising:
a support surface including a longitudinal axis,
at least one helical thread extending along said support surface,
a plurality of generally V-shaped voids in said thread for capture of viscera therein.

2. The probe as claimed in claim 1 wherein each thread of said at least one helical threads comprises a pitch of approximately between 30 to 120 millimeters.

3. The probe as claimed in claim 1 wherein each thread of said at least one helical threads comprises a pitch of approximately 60 millimeters.

4. The probe as claimed in claim 1 further comprising a means for attaching said probe to a probe extension rod.

5. The probe as claimed in claim 4 wherein said means for attaching comprises a threaded void in said probe for receiving said probe extension rod therein.

6. The probe as claimed in claim 1 wherein said V-shaped void is an acute angle formed by a first cut and a second cut at an angle of between 5 degrees and 10 degrees from said first cut.

7. The probe as claimed in claim 1 wherein said support surface is generally cylindrical.

8. The probe as claimed in claim 1 wherein said support surface is generally conical.

9. The probe as claimed in claim 7 wherein said V-shaped void is an acute angle formed by a first cut made generally tangent to said cylindrical support surface and said second cut is spaced approximately between 5 degrees and 10 degrees from said first cut.

10. The probe as claimed in claim 9 wherein said second cut is generally tangent to said cylindrical support surface.

11. The probe as claimed in claim 1 wherein at least a portion of said plurality of V-shaped voids are located along a single line that is parallel to said longitudinal axis of said support surface.

12. The probe as claimed in claim 1 wherein said at least one helical thread comprises:
a first helical thread extending along said support surface from a first starting point,
a second helical thread extending along said support surface from a second starting point, and
a third helical thread extending along said support surface from a third starting point,
wherein said first, second and third starting points are each spaced at generally 120 degrees from each other about a cross-section perpendicular to said longitudinal axis of said support surface.

13. The probe as claimed in claim 1 wherein an outer perimeter of said at least one helical thread defines a maximum probe diameter.

14. The probe as claimed in claim 13 wherein said maximum probe diameter is greater than a distal end diameter.

15. The probe as claimed in claim 1 wherein said support surface and/or said at least one helical thread are flexibly structured.

16. A probe for attachment to a rotatable probe shaft, for removing undesired viscera from the neck of an eviscerated and decapitated bird carcass comprising:
a support surface,
a plurality of teeth protruding from said support surface, each of said plurality of teeth including a tooth end, a leading surface and a trailing surface, said trailing surface diverging from said leading surface away from said tooth end, and
a void comprising an acute angle formed between a trailing surface of a lead one of said plurality of teeth and a leading surface of another one of said plurality of teeth which trails said lead one of said plurality of teeth.

17. The probe as claimed in claim 16 wherein at least a portion of said plurality of teeth are positioned in at least one helical pattern along said support surface.

18. The probe as claimed in claim 17 wherein at least another portion of said plurality of teeth are positioned in at least another helical pattern along said support surface, said at least another helical pattern being spaced apart from said at least one helical pattern.

19. The probe as claimed in claim 16 wherein said trailing surface of each of said plurality of teeth defines a maximum probe diameter.

20. The probe as claimed in claim 19 wherein said maximum probe diameter is greater than a distal end diameter.

21. The probe as claimed in claim 16 wherein said support surface and/or said plurality of teeth are flexibly structured.

22. The probe as claimed in claim 16 further comprising a lead-in for said lead one of said plurality of teeth, said lead-in not comprising a trailing surface of any of said plurality of teeth.

23. A probe for attachment to a rotatable probe shaft, for removing undesired viscera from the neck of an eviscerated and decapitated bird carcass comprising:
a support surface including a longitudinal axis,
at least one helical thread extending along said support surface, said at least one helical thread including an outer perimeter, said outer perimeter defining a maximum probe diameter,
a plurality of voids in said at least one helical thread for capture of viscera therein, and
a distal end diameter, said distal end diameter being smaller than said maximum probe diameter.

24. A cam for use in food processing machinery comprising:
a frame,
a first plastic guide attached to said frame, said first plastic guide being pre-shaped to define a first follower boundary on said frame, and
a second plastic guide attached to said frame spaced apart from said first plastic guide, said second plastic guide being pre-shaped to define a second follower boundary on said frame.

25. The cam as claimed in claim 24 wherein said frame comprises:
an upper support member adapted to be mounted to a vertical axle,
a lower support member adapted to be mounted to the vertical axle, and
a plurality of vertical support members connected to said upper and said lower support members, said vertical support members adapted for attachment to said first and said second plastic guides.

26. The cam as claimed in claim 25 wherein each of said plurality of vertical support members includes a plurality of connection points adapted to universally attach to first and/or second plastic guides of varying follower boundaries.

27. The cam as claimed in claim 26 wherein said plurality of connection points comprise a plurality of circular voids extending through each of said plurality of vertical support members.

28. The cam as claimed in claim 24 wherein said first and second plastic guides are pre-shaped in two dimensions.

29. The cam as claimed in claim 28 wherein said first and second follower boundaries exist in three dimensions.

30. The cam as claimed in claim 29 further comprising a removable connection to attach said first and second plastic guides to said frame.

31. A method of manufacturing a cam for use in food processing machinery comprising the steps of:
establishing a desired three-dimensional follower boundary about a cam,
determining a two-dimensional representation of said desired three-dimensional follower boundary,
utilizing said two-dimensional representation to shape a plastic guide in two dimensions,
wrapping said plastic guide about the cam along said desired three-dimensional follower boundary to form a follower boundary.

32. The method as claimed in claim 31 further comprising the step of repeating said establishing, determining, utilizing and wrapping steps to form additional follower boundaries.

33. The method as claimed in claim 31 further comprising the step of attaching said plastic guide to the cam.

34. The method as claimed in claim 33 wherein said plastic guide is attached to said cam via a removable connection.
